(19) United States
(12) Patent Application Publication
(10) Pub. No.: US 2013/0204918 A1
(43) Pub. Date: Aug. 8, 2013

(54) COMPUTING ENVIRONMENT CONFIGURATION AND INITIALIZATION

(71) Applicants: Rohith K. Ashok, Apex, NC (US); Michael J. Burr, Cary, NC (US); Christine B. Chato, Durham, NC (US); Adam R. Geiger, Cary, NC (US); Matt R. Hogstrom, Cary, NC (US); Michael S. Law, Morrisville, NC (US); Matthew J. Sheard, Morrisville, NC (US)

(72) Inventors: Rohith K. Ashok, Apex, NC (US); Michael J. Burr, Cary, NC (US); Christine B. Chato, Durham, NC (US); Adam R. Geiger, Cary, NC (US); Matt R. Hogstrom, Cary, NC (US); Michael S. Law, Morrisville, NC (US); Matthew J. Sheard, Morrisville, NC (US)

(73) Assignee: International Business Machines Corporation, Armonk, NY (US)

(21) Appl. No.: 13/368,446

(22) Filed: Feb. 8, 2012

(51) Int. Cl. G06F 15/16

(52) U.S. Cl. 709/201

(57) ABSTRACT

According to one aspect of the present disclosure a method and technique for automatically configuring a set of resources for deployment as a computing environment is disclosed. The method includes: executing a configuration management application, the configuration management application configured to automatically connect to and discover each hardware element forming a networked set of resources; determine whether each discovered hardware element is specified for the computing environment; responsive to determining that each discovered hardware element is specified for the computing environment, determine a configuration setting for each respective discovered hardware element; responsive to determining that the configuration setting of the discovered hardware element conflicts with a desired configuration setting for deployment of the discovered hardware element, automatically configure the discovered hardware element to the desired configuration setting; and automatically load and configure a management interface to enable deployment of the networked set of resources as a computing environment.

### BACKGROUND

Building a computing environment, for deployment as a cloud computing environment or other use, generally requires a user to purchase and integrate a variety of different computer hardware and/or software elements. For example, individual physical machines may need to be acquired. A machine may include internal storage or the user may add external storage devices for the system. Switches may also be acquired and used to network the various elements. Software components are then generally needed to be installed for each hardware component to enable the resources to interoperate.

### BRIEF SUMMARY

According to one aspect of the present disclosure a method and technique for automatically configuring a set of resources for deployment as a computing environment is disclosed. The method includes: executing a configuration management application, the configuration management application configured to automatically connect to and discover each hardware element forming a networked set of resources; determine whether each discovered hardware element is specified for the computing environment; responsive to determining that each discovered hardware element is specified for the computing environment, determine a configuration setting for each respective discovered hardware element; responsive to determining that the configuration setting of the discovered hardware element conflicts with a desired configuration setting for deployment of the discovered hardware element, automatically configure the discovered hardware element to the desired configuration setting; and automatically load and configure a management interface to enable deployment of the networked set of resources as a computing environment.

### BRIEF DESCRIPTION OF THE SEVERAL VIEWS OF THE DRAWINGS

For a more complete understanding of the present application, the objects and advantages thereof, reference is now made to the following descriptions taken in conjunction with the accompanying drawings, in which:

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 depicts an embodiment of a data processing system in which illustrative embodiments of a system for automatically configuring a set of resources for deployment as a computing environment may be implemented; and

FIG. 5 depicts a flow diagram illustrating an embodiment of a method for automatically configuring a set of resources for deployment as a computing environment.

### DETAILED DESCRIPTION

Embodiments of the present disclosure provide a method, system and computer program product for automatically configuring a set of resources for deployment as a computing environment. For example, in some embodiments, the method and technique includes: executing a configuration management application, the configuration management application configured to automatically connect to and discover each hardware element forming a networked set of resources; determine whether each discovered hardware element is specified for the computing environment; responsive to determining that each discovered hardware element is specified for the computing environment, determine a configuration setting for each respective discovered hardware element; responsive to determining that the configuration setting of the discovered hardware element conflicts with a desired configuration setting for deployment of the discovered hardware element, automatically configure the discovered hardware element to the desired configuration setting; and automatically load and configure a management interface to enable deployment of the networked set of resources as a computing environment. Thus, embodiments of the present disclosure enable a pre-assembled collection of hardware resources to be automatically configured and deployed as a computing environment. For example, embodiments of the present disclosure enable the different hardware resource elements to be verified and configured without user intervention. Further, embodiments of the present disclosure provide a user with an integrated hardware resource set having an integrated solution that automatically discovers and configures the resources and provides a single and/or unified management interface for the system as a cloud computing environment.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer usable or computer readable medium(s) may be utilized. The computer readable medium may be a computer readable signal medium or a computer readable storage medium. A computer readable storage medium may be, for example but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with and instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for loadbalancing between clouds).

A cloud computing environment is service oriented with a focus on statelessness, low coupling, modularity, and semantic interoperability. At the heart of cloud computing is an infrastructure comprising a network of interconnected nodes.

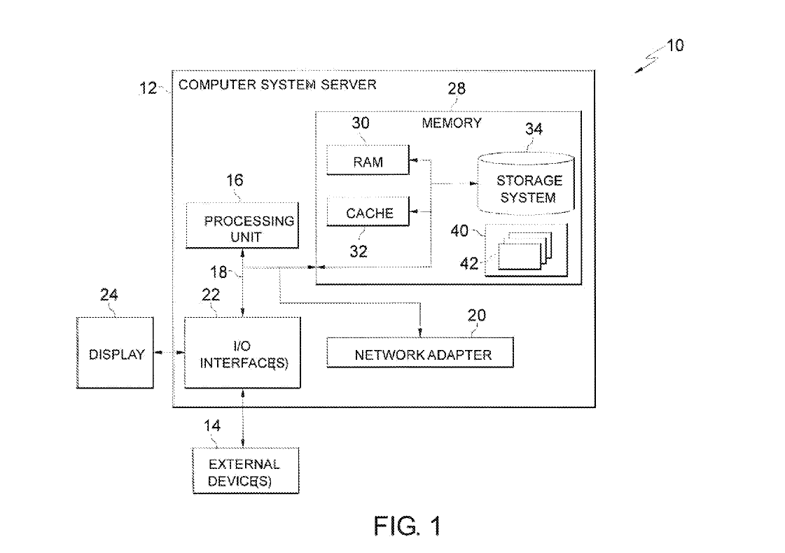

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

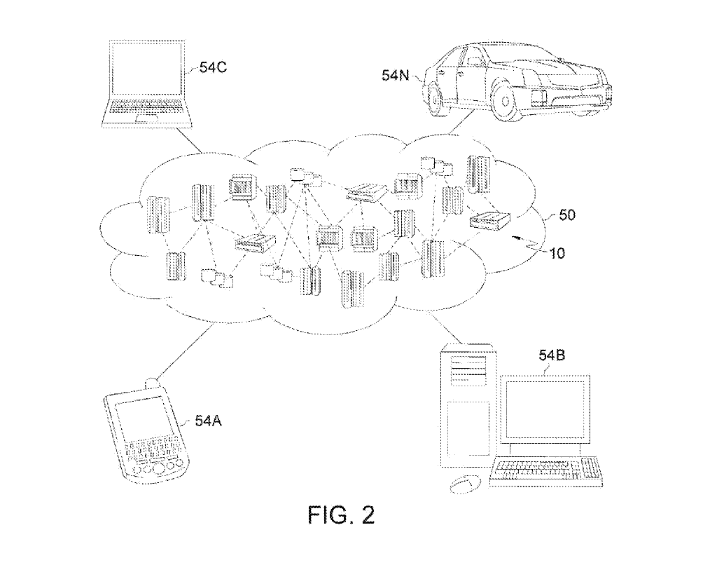

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

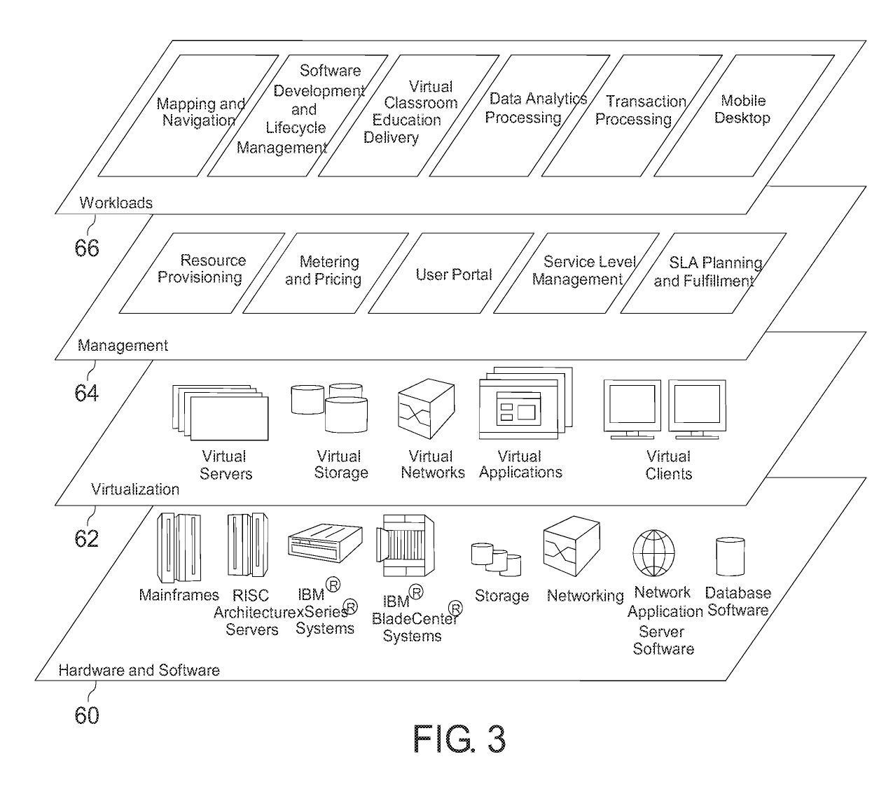

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual machines, including virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. Service level management may also include virtual machine allocation and management such that the migration and/or execution of virtual machine resources (e.g., various workload or application processing) complies with the geophysical host location.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and mobile desktop functions.

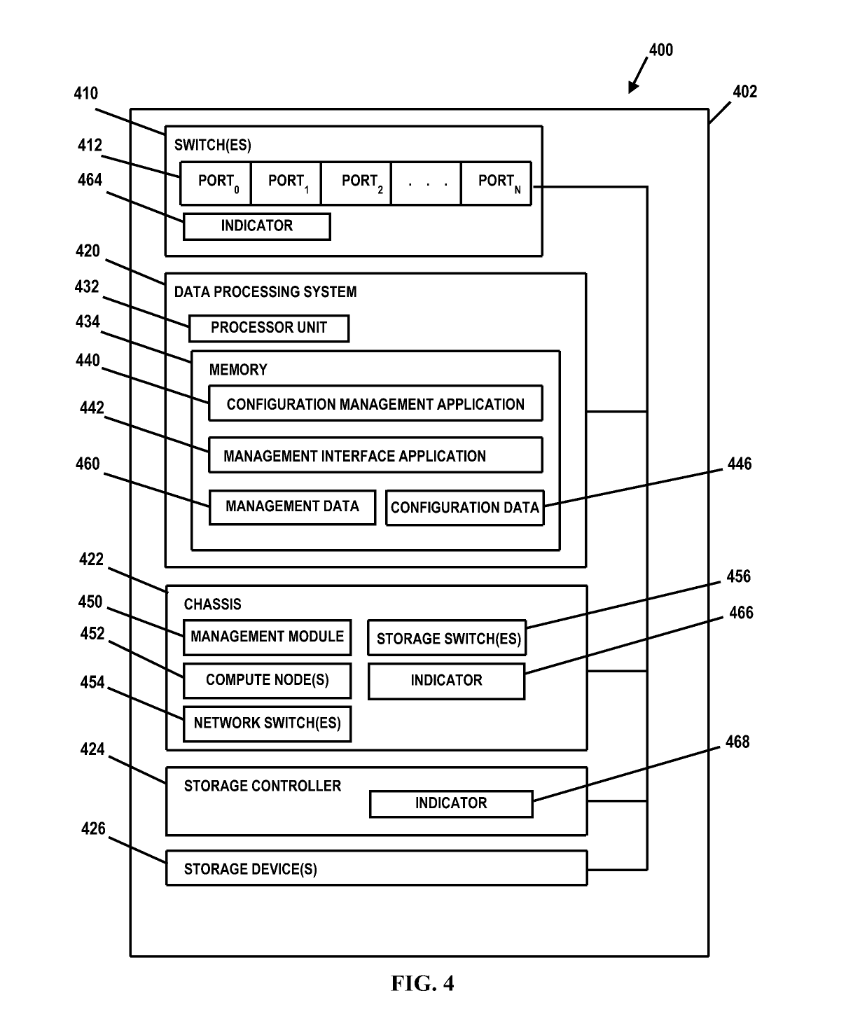

FIG. 4 is an illustrative embodiment of a system 400 for automatically configuring a set of resources for deployment as a cloud computing environment. System 400 may be implemented on data processing systems or platforms such as, but not limited to, node 10 or at other data processing system locations. System 400 (e.g., all or portions thereof) may be implemented, for example, on hardware and software layer 60 and/or on management layer 64 as depicted in FIG. 3. In the embodiment illustrated in FIG. 4, system 400 comprises a set of hardware elements or resources that may be pre-connected and/or otherwise pre-assembled as a unified collection of hardware elements. For example, in the embodiment illustrated in FIG. 4, system 400 comprises a rack 402 with different hardware elements located at various rack locations/positions. However, it should be understood that system 400 may include multiple racks and/or off-rack hardware elements. The hardware elements located in rack 402 are cabled and/or otherwise connected together to form a networked set of hardware elements/resources for deployment as a computing environment.

In the embodiment illustrated in FIG. 4, system 400 includes one or more switches 410 (e.g., top-of-rack switches) having a number of different switch ports 412 for connecting and/or networking the various hardware elements of system 400. In FIG. 4, system 400 also includes a data processing system 420, a chassis 422, a storage controller 424, and one or more storage devices 426. It should be understood that system 400 may include other hardware elements (e.g., network switches, storage switches, etc.) and that the types and/or quantities of hardware elements may vary in system 400 (e.g., additional chassis, storage controllers, storage devices, etc.). In FIG. 4, data processing system 420 may comprise a server blade or other type of computing platform having a processor unit 432 (e.g., CPU) capable of reading and executing instructions and/or running a variety of types of applications and a memory 434. In the embodiment illustrated in FIG. 4, memory 434 comprises a configuration management application 440 and a management interface application 442. Configuration management application 440 and management interface application 442 may be implemented in any suitable manner that may be hardware-based, software-based, or some combination of both. For example, configuration management application 440 and management interface application 442 may comprise software, logic and/or executable code for performing various functions as described herein (e.g., residing as software and/or an algorithm running on a processor unit, hardware logic residing in a processor or other type of logic chip, centralized in a single integrated circuit or distributed among different chips in a data processing system). Configuration management application 440 is configured to automatically access, verify the identity/version, test/analyze and configure the various hardware elements of system 400 for deployment as an interoperating networked set of hardware resources for a computing environment (e.g., alleviating a need for a user to manually configure the various elements of system 400). Management interface application 442 is configured to enable management of the hardware elements of system 400 as a computing environment (e.g., enabling the different hardware elements of system 400 to be managed as a unified set of resources). In some embodiments, management interface application 442 may comprise one or more software components that are loaded onto distinct hardware elements of system 400 to enable management of the different hardware elements of system 400 as a unified computing environment.

In the embodiment illustrated in FIG. 4, memory 434 also includes configuration data 446. Configuration data 446 includes information correlating a connection of each hardware element of system 400 to another hardware element(s) of system, 400 (e.g. to a corresponding port 412 of switch 410). For example, a cabling or connection system may be used to network various hardware elements of system 400 (e.g., via network switches, such as switch 410). Configuration data 446 correlates a physical location of a particular hardware element in rack 402 to a particular port 412 of switch 410 (as applicable). Thus, in some embodiments, configuration data 446 defines a particular resource set of hardware elements for system 400. For example, configuration data 446 may define a particular quantity and model of a hardware element (e.g., a compute chassis) in system 400 and the corresponding physical location of such hardware elements in rack 402 (including the respective port 412 each hardware element is connected to, as applicable). Thus, configuration data 446 may be used to define a particular hardware resource set for system 400 and define the physical location (and port connections) of the hardware resources within rack 402. Thus, in some embodiments, the respective ports 412 may be used by management application 440 to learn the physical location of particular hardware elements in rack 402. Configuration data 446 may be used to verify that, for a particular port 412, that a particular hardware element is connected to the respective port 412 as defined by configuration data 446. Configuration data 446 may also set forth and/or otherwise define/specify a particular configuration setting for each hardware and/or software element forming part of or comprising system 400 (e.g., the firmware level, the types and/or content of certain configuration files, etc.). Configuration data 446 may comprise a database file, a USB key/drive with data, radio frequency identification data (RFID), or any other type of data transport and/or storage mechanism.

In the embodiment illustrated in FIG. 4, chassis 422 comprises a chassis management module 450, one or more compute nodes 452, one or more network switches 454 and one or more storage switches 456. However, it should be understood that the quantity and type of hardware elements disposed in and/or forming part of chassis 422 may vary. Further, it should be understood that system 400 may contain multiple chassis each having similar or different hardware elements contained therein. Management module 450 is generally used to control, monitor and/or manage the various hardware elements contained in and/or otherwise forming part of the particular chassis 422.

In operation, configuration management application 440 is used to automatically configure the set of hardware resources forming system 400 to enable the various hardware elements to be deployed and managed as a unified and interoperating computing environment. Application 440 is configured to discover each hardware element forming part of system 400, determine the identity (e.g., type, model, firmware level, etc.) of the discovered hardware element, verify that the discovered hardware element is a hardware element that is expected to be in system 400 (e.g., according to a predetermined set of hardware elements intended to form system 400 and/or the particular hardware element that is expected to be connected to a particular port 412 of switch 410), test/analyze the discovered hardware element (e.g., to determine whether the hardware element has been configured according to particular configuration setting (e.g., according to a predefined or desired configuration as indicated by, for example, configuration data 446)) and, if the discovered hardware element has not been configured according to a desired configuration, automatically configure the hardware element (e.g., update firmware, set up configuration files, configure usernames/passwords, etc.). In some embodiments, application 440 iteratively steps through each hardware element in system 400 and, in response to detecting a failure at a particular hardware element (e.g., discovering a factory default configuration, a non-standard configuration, an unexpected configuration and/or a configuration other than a configuration desired for the particular hardware element), automatically configures (or re-configures) the hardware element and then repeats the process. For example, after configuring the discovered hardware element, application 440 may begin from the beginning of the process (e.g., using configuration data 446 to set forth a list or order of hardware elements in system 400 and/or expected to be in system 400) by testing and verifying each hardware element in system 400 (including those hardware elements previously discovered and configured) until another failure is detected (e.g., a next hardware element in system 400 detected that is not configured according to a desired configuration). Thus, in some embodiments, application 440 iteratively repeats the process of discovering, verifying and configuring (as needed) each hardware element in system 400 until all hardware elements in system 400 have been discovered, verified and configured. In some embodiments, if a hardware element is discovered that should not form part of system 400 (e.g., not included in configuration data 446), the error or failure condition is flagged and/or otherwise indicated (e.g., visual alert, audio alert, etc.).

Thus, upon initialization of application 440, application 440 accesses configuration data 446 to gather information associated with expected hardware elements forming system 400. In some embodiments, application 440 initially accesses and queries switch(es) 410. Application 440 identifies switch(es) 410 and determines whether switch 410 corresponds to a switch indicated by configuration data 446. If not, an error indication is performed. Otherwise, application 440 proceeds to determine whether switch 410 is configured for operation/deployment. In response to determining an error indication that switch 410 is not configuration to the desired configuration, application 440 proceeds to configure switch 410 by configuring/activating ports 412 for accessing the connected hardware elements of system 400. Application 440 may activate one port 412 at a time or activate multiple ports 412 before accessing different hardware elements connected to switch 410. For example, in some embodiments, in response to activating PORT°, application 440 may proceed to access the hardware element connected to PORT° before activating another port 412 of switch 410. In other embodiments, application may activate all ports 412 of switch 410 before attempting to access hardware elements connected to the various ports 412 of switch 410.

After activating one or more ports 412 of switch 410, application 440 selects one of ports 412 and accesses a corresponding hardware element connected to the selected port 412. For example, the first port selected may be PORT°, and management module 450 of chassis 422 may be connected to PORT₀. Application 440, via PORT₀, accesses and queries the hardware element connected to PORT₀ to determine an identity of the hardware element connected to PORT₀ and verifies that the hardware element connected to PORT₀ corresponds to the hardware element defined by configuration data 446 for PORT₀. In some embodiments (e.g., depending on the type(s) of hardware elements being verified), verifying the cable connection between respective hardware elements may be performed by checking ports on both ends of the cable and sending a sample ping through the cable. If the hardware element connected to PORT₀ does not correspond to the hardware element defined by configuration data 446, an error indicated is processed. Otherwise, application 440 proceeds to determine whether the discovered hardware element (management module 450) is configured for operation/deployment. In response to determining an error/failure indication that management module 450 is not configured to the desired configuration, application 440 proceeds to configure management module 450.

In some embodiments, in response to configuring management module 450, application 440 re-initiates the discovery process by performing the discovery/testing process from the beginning For example, application 440 re-discovers switch 410, verifies switch 410 based on configuration data 446, determines whether switch 410 is configured, responsive to determining that switch 410 is configured, discovers the hardware element connected to PORT₀ (management module 450), verifies the identity of management module 450, determines whether management module 450 is configured, and responsive to detecting the management module 450 is configured, proceeds to discover a next hardware element of system 400 (e.g., select another port 412 (e.g., PORT₁) for the above process or proceed to discover/configure other hardware elements of chassis 422). Thus, in this embodiment, application 440 iteratively proceeds through the hardware elements of system 400 from the beginning after each failure detection (e.g., detecting that a hardware element is not configured to the desired configuration). In this manner, application 440 repeats the process of stepping incrementally through the hardware elements of system 400 and responding to and/or repairing each discovered error or failure that is detected.

In some embodiments, application 440 first discovers, analyzes, detects any hardware failure or error conditions and repairs such conditions before performing a similar procedure on lower level hardware elements. For example, in some embodiments, application 440 may first discover, detect and repair any failure conditions for each hardware element connected directly to a port 412 of switch (e.g., each chassis 422, storage controller 424, or other hardware elements) before performing a similar process on hardware elements that may be controlled and/or managed by such higher level hardware elements. As an example, in some embodiments, application 440 may first discover and configure each chassis 422 (e.g., chassis management module 450) before discovering, detecting any hardware failure or error conditions and repairing such condition corresponding to compute nodes 452, storage switches 456 and/or network switches 454 managed and/or controlled by a configured management module 450 in a particular chassis 422. After configuring each chassis 422, application 440 may discover, detect any hardware failure or error conditions corresponding to storage controllers 424 and repair such conditions, then perform a similar process for storage devices 426 controlled and/or managed by such storage controllers 424. Thus, it should be understood that the order of discovery, error detection and repair may be varied.

After the hardware elements of system 400 have been configured, application 440 initiates and/or otherwise configures management application interface 442 to enable a management interface for system 400. For example, in some embodiments, application 440 loads software and/or middleware components onto the various hardware elements of system 400 (e.g., hypervisors and/or other virtualization resources), exchanges secure channel communication keys between the various hardware elements of system 400, populates a database or other data repository (illustrated as management data 460 in FIG. 4) storing configuration information associated with the various hardware elements of system 400 such as, but not limited to, IPaddresses and username/passwords for accessing/managing the hardware elements of system 400. In some embodiments, application 440 sets up and utilizes an isolated network for the configuration and management of hardware elements of system 400 that is distinct from a user or third party network, thereby ensuring that IPaddresses of the hardware resources of system 400 do not conflict with other networks or IPaddresses. In some embodiments, Internet Protocol version 6 (IPv6) link-local addressing or user-based LAN access control (ULA) mechanisms may be used to prevent address collisions. In some embodiments, management application interface 442 enables a user of system 400 to further configure/tailor system 400 according to user-specified requirements or the user's environment. For example, application 440 runs to configure system 400 to a certain level of configuration (e.g., pre-configure system 400) such that an additional level of configuration may be performed by a user of system 400 via management application interface 442 to further configure/tailor system 400 for the user's environment/application.

In some embodiments, application 440 causes an indication to be emitted while a particular hardware element is being configured, thereby enabling a user to verify a physical location of the hardware element (e.g., a physical location of the hardware element within rack 402) and/or otherwise identify the particular hardware element during processing/configuring. For example, in FIG. 4, switch 410, chassis 422 and storage controller 424 each include an indicator 464, 466 and 468, respectively. Indicators 464, 466 and 468 may comprise light emitting diodes (LEDs) or any other type of indicator (e.g., audio and/or visual). Thus, in operation, in response to application 440 accessing and configuring a particular hardware element of system 400 (e.g., chassis 422), application 440 causes indicator 466 to be illuminated (e.g., steady on state, blinking, etc.), thereby enabling a user of system 400 to visually verify the physical location of chassis 422 in rack 402 and monitor the configuration process of system 400.

Application 440 may also be used to perform configuration management processing in connection with hardware modifications and/or upgrade associated with hardware changes for system 400. For example, after any new and/or replacement hardware elements are incorporated in system 400, application 440 may be run to reset the hardware elements of system 400 and/or otherwise configure any new/replacement hardware elements of system 400. Further, if a hardware element fails, application 440 may be run to identify the hardware element failure and/or identify steps that may be performed to correct the failure.

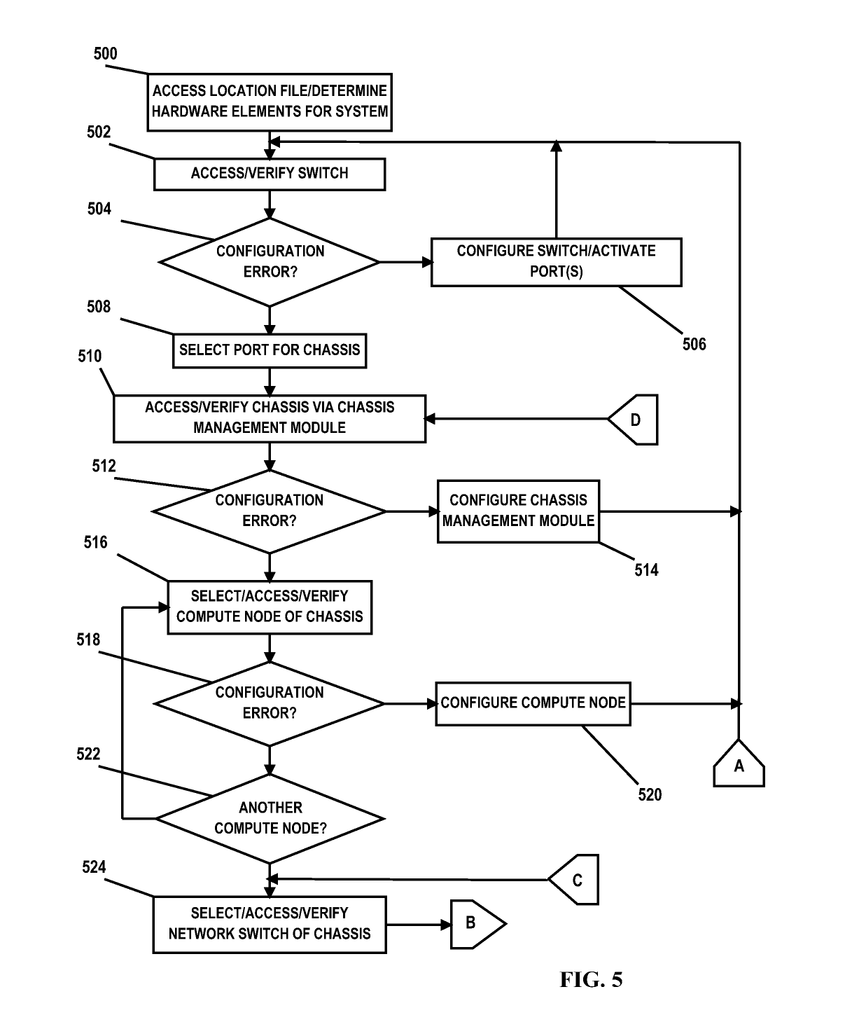

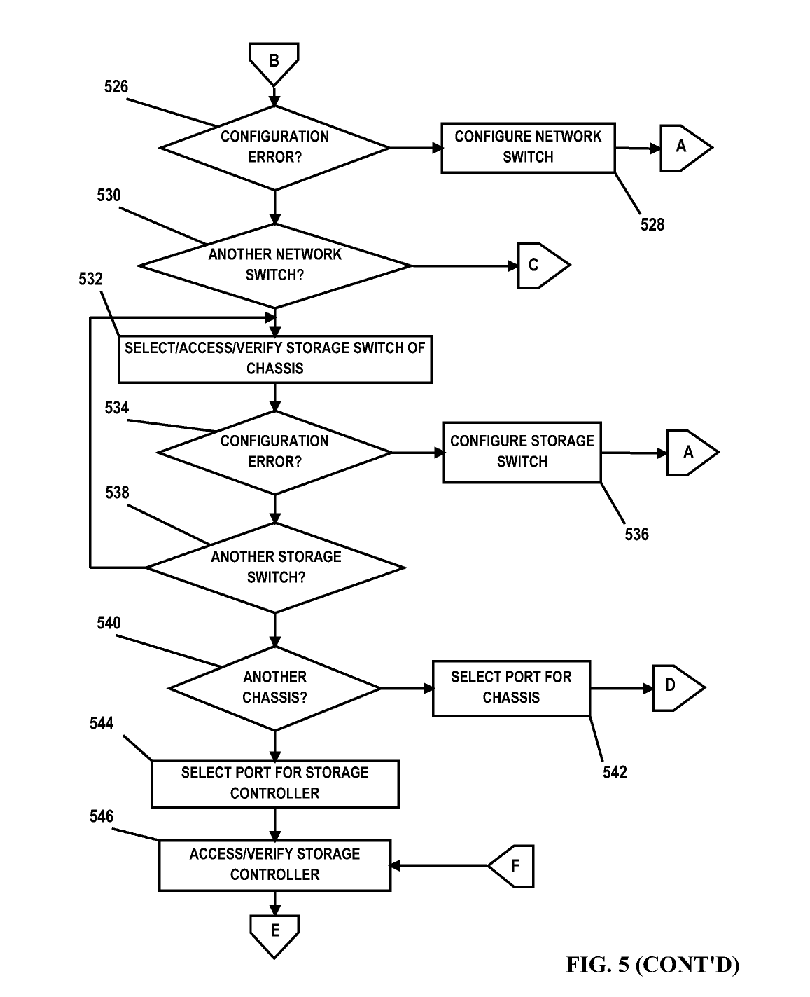

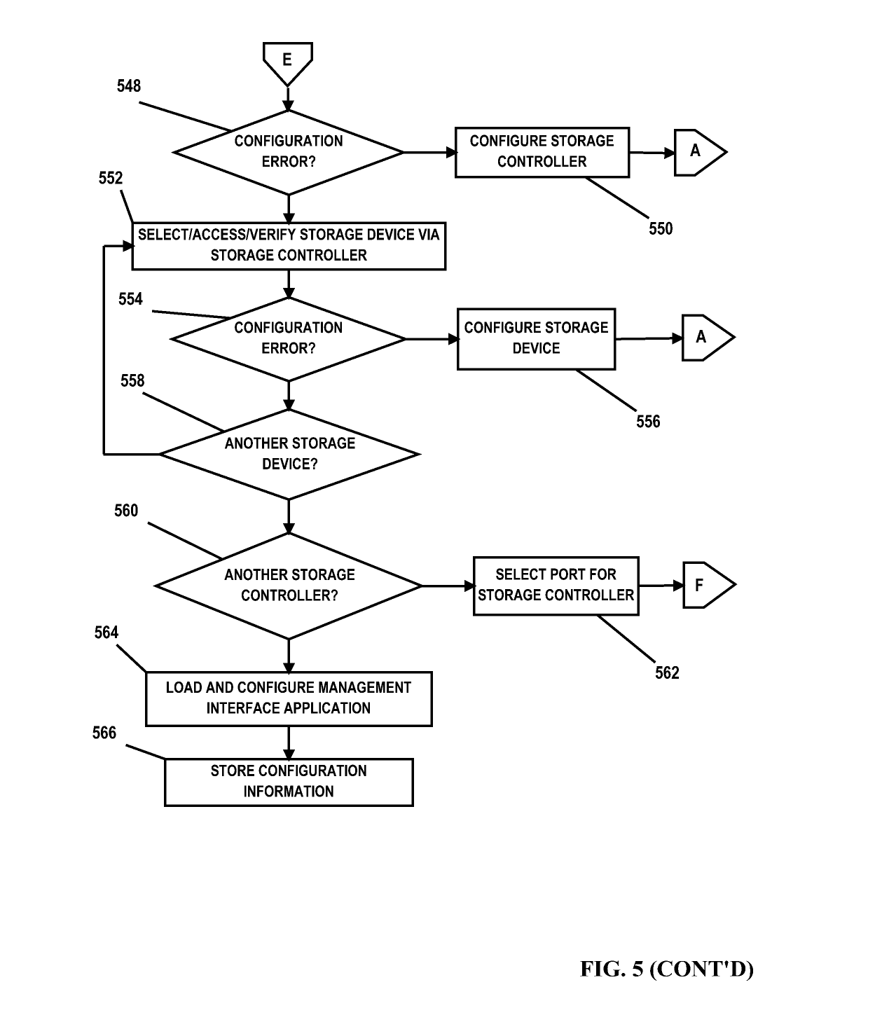

FIG. 5 is a flow diagram illustrating an embodiment of a method for automatically configuring a set resources for deployment as a computing environment. The method begins at block 502, where application 440 is initialized and access configuration data 446 to determine the particular set of resources expected to form system 400 and the port 412 connections for the various resources. At block 502, application 440 access switch 410 and verifies that the discovered switch corresponds to the switch indicated by configuration data 446. At decisional block 504, application 440 determines whether a hardware error and/or failure condition is detected corresponding to switch 410 (e.g., detecting that switch 410 is not configured to the desired configuration). If so, the method proceeds to block 506, where application 440 configures switch 410 and/or activates one or more ports 412 of switch 410 to enable access to the various hardware elements connected to switch 410. The method then proceeds to block 502 where application 440 repeats the process of accessing, verifying and testing the condition of switch 410. If at decisional block 504 it is determined that a failure and/or error condition is not present (e.g., switch 410 was previously configured), the method proceeds to block 508. In this example, a single switch 410 is described; however, it should be understood that if it is determined that a failure and/or error condition is not present at block 504 corresponding to a particular switch, another switch (if present) may be selected, verified and analyzed.

At block 508, application 440 selects a particular port 412 for accessing a corresponding hardware element of system 400 (e.g., on of chassis 422). For example, application 440 may be configured to access, verify and test certain hardware elements in a particular order (e.g., discover, verify and test for each chassis in system 400; then discover, verify and test for each hardware element in a particular chassis; then discover, verify and test for each storage controller in system 400; then discover, verify and test for each storage device controlled by and/or managed by a particular storage controller). Thus, it should be understood that the particular sequence of ports 412 and/or hardware elements selected may vary. In the example depicted in FIG. 5, discovering/verifying chassis is performed following the configuring of switch 410.

At block 510, application 440, via the selected port, accesses the connected hardware element and queries the connected hardware element for identifying information (e.g., model signature information, firmware level, etc.). Application 440 verifies that the hardware element connected to the selected port 412 corresponds to the hardware element expected to be connected to the selected port 412 (e.g., as indicated by configuration data 446). In this example, application 440 accesses and queries management module 450 of chassis 422. At decisional block 512, application 440 determines whether a hardware error and/or failure condition is detected corresponding to management module 450 (e.g., detecting that management module 450 is not configured to the desired configuration). If so, the method proceeds to block 514, where application 440 configures management module 450. The method then proceeds to block 502 where application 440 repeats the process of accessing, verifying and testing the condition of hardware elements of system 400 based on configuration data 446. If at decisional block 512 it is determined that a failure and/or error condition is not present (e.g., management module 450 was previously configured), the method proceeds to block 516.

At block 516, application 440 selects and/or otherwise accesses a hardware element of a particular chassis 422 that is controlled and/or otherwise managed by a configured management module 450 (e.g., one of compute nodes 452). As described earlier, application 440 may be configured to configure each hardware element of a particular chassis before continuing with another chassis or first discover and configure management modules for each chassis of system 400 before configuring managed hardware elements of each chassis. In the example depicted in FIG. 5, application 440 is configured to access, verify, test and configure the hardware elements of a particular chassis 422. Thus, at block 516, application 440 access and particular compute node 452 of chassis 422, queries the selected compute node 452 for identification/configuration information, and verifies that the discovered compute node 452 corresponds to the compute node expected based on configuration data 446. At decisional block 518, application 440 determines whether a hardware error and/or failure condition is detected corresponding to compute node 452 (e.g., detecting that compute node 452 is not configured to the desired configuration). If so, the method proceeds to block 520, where application 440 configures compute node 452. The method then proceeds to block 502 where application 440 repeats the process of accessing, verifying and testing the condition of hardware elements of system 400 based on configuration data 446. If at decisional block 518 it is determined that a failure and/or error condition is not present (e.g., compute node 452 was previously configured), the method proceeds to decisional block 522 where a determination is made whether there is another compute node of chassis 422 to access, verify and, if needed, configure. If so, the method proceeds to block 516 for the next compute node. Otherwise, the method proceeds to block 524 (e.g., after all compute nodes of a particular chassis 422 have been configured).

At block 524, application 440 selects and accesses a network switch 454 of the particular chassis 422. Application 440 queries and//or otherwise acquires identification and/or configuration information corresponding to the selected network switch 454 and verifies that the discovered network switch corresponds to the expected network switch as set forth in configuration data 446. At decisional block 526, application 440 determines whether a hardware error and/or failure condition is detected corresponding to the selected network switch 454 (e.g., detecting that the identified network switch 454 is not configured to the desired configuration). If so, the method proceeds to block 528, where application 440 configures the network switch 454. The method then proceeds to block 502 where application 440 repeats the process of accessing, verifying and testing the condition of hardware elements of system 400 based on configuration data 446. If at decisional block 526 it is determined that a failure and/or error condition is not present (e.g., the particular network switch 454 was previously configured), the method proceeds to decisional block 530 where a determination is made whether there is another network switch of chassis 422 to access, verify and, if needed, configure. If so, the method proceeds to block 524 for the next network switch. Otherwise, the method proceeds to block 532 (e.g., after all network switches of a particular chassis 422 have been configured).

At block 532, application 440 selects and accesses a storage switch 456 of the particular chassis 422. Application 440 queries and//or otherwise acquires identification and/or configuration information corresponding to the selected storage switch 456 and verifies that the discovered storage switch corresponds to the expected storage switch for the particular chassis 422 as set forth in configuration data 446. At decisional block 534, application 440 determines whether a hardware error and/or failure condition is detected corresponding to the selected storage switch 456 (e.g., detecting that the identified storage switch 456 is not configured to the desired configuration). If so, the method proceeds to block 536, where application 440 configures the storage switch 456. The method then proceeds to block 502 where application 440 repeats the process of accessing, verifying and testing the condition of hardware elements of system 400 based on configuration data 446. If at decisional block 534 it is determined that a failure and/or error condition is not present (e.g., the particular storage switch 456 was previously configured), the method proceeds to decisional block 538 where a determination is made whether there is another storage switch of chassis 422 to access, verify and, if needed, configure. If so, the method proceeds to block 532 for the next storage switch. Otherwise, the method proceeds to decisional block 540 (e.g., after all storage switches of a particular chassis 422 have been configured).

At decisional block 540, it is determined whether another chassis 422 needs to be accessed/configured (e.g., based on configuration data 446). If so, the method proceeds to block 542 where application 440 selects another port 412 of switch corresponding to a next chassis 422 of system 400. The method then proceeds to block 510 where the above process is performed for a next chassis 422 of system 400. If at decisional block 540 it is determined that there are no other chassis to access/configure, the method proceeds to block 544.

At block 544, application 440 selects a port 412 corresponding to an expected storage controller. At block 546, application 440, via the selected port 412, accesses the connected hardware element and queries the connected hardware element for identifying information (e.g., model signature information, firmware level, etc.). Application 440 verifies that the hardware element connected to the selected port 412 corresponds to the hardware element expected to be connected to the selected port 412 (e.g., as indicated by configuration data 446). In this example, application 440 accesses and queries storage controller 424 of chassis 422 and verifies that the discovered storage controller 424 corresponds to the expected storage controller as defined by configuration data 446. At decisional block 548, application 440 determines whether a hardware error and/or failure condition is detected corresponding to storage controller 424 (e.g., detecting that storage controller 424 is not configured to the desired configuration). If so, the method proceeds to block 550, where application 440 configures storage controller 424. The method then proceeds to block 502 where application 440 repeats the process of accessing, verifying and testing the condition of hardware elements of system 400 based on configuration data 446. If at decisional block 548 it is determined that a failure and/or error condition is not present (e.g., storage controller 424 was previously configured), the method proceeds to block 552.

At block 552, application 440, via a corresponding storage controller 424, selects and accesses a storage device 426 managed by the particular storage controller 424. Application 440 queries and//or otherwise acquires identification and/or configuration information corresponding to the selected storage device 426 and verifies that the discovered storage device corresponds to the expected storage device for the particular storage controller 424 as set forth in configuration data 446. At decisional block 554, application 440 determines whether a hardware error and/or failure condition is detected corresponding to the selected storage device 426 (e.g., detecting that the identified storage device 426 is not configured to the desired configuration). If so, the method proceeds to block 556, where application 440 configures the storage device 426. The method then proceeds to block 502 where application 440 repeats the process of accessing, verifying and testing the condition of hardware elements of system 400 based on configuration data 446. If at decisional block 554 it is determined that a failure and/or error condition is not present (e.g., the particular storage device 426 was previously configured), the method proceeds to decisional block 558 where a determination is made whether there is another storage device managed by the particular storage controller 424 to access, verify and, if needed, configure. If so, the method proceeds to block 552 for the next storage device. Otherwise, the method proceeds to decisional block 560 (e.g., after all storage devices managed by a particular storage controller 424 have been configured).

At decisional block 560, it is determined whether another storage controller needs to be accessed/configured (e.g., based on configuration data 446). If so, the method proceeds to block 562 where application 440 selects another port 412 of switch corresponding to a next storage controller 424 of system 400. The method then proceeds to block 546 where the above process is performed for a next storage controller 424 of system 400. If at decisional block 560 it is determined that there are no other storage controllers to access/configure, the method proceeds to block 564. At block 564, application 440 loads and configures management interface application 442. Application 440 may load, initiate and configure various software components onto the different hardware elements of system 400, exchange secure channel communication keys, and acquire and/or otherwise generate usernames and passwords for managing the hardware resource elements of system 400. At block 566 application 440 stores and/or otherwise populates a database with the configuration information corresponding to the hardware elements of system 400 (e.g., management data 460).

Thus, embodiments of the present disclosure enable a pre-assembled collection of hardware resources to be automatically configured and deployed as a computing environment. For example, embodiments of the present disclosure enable the different hardware resource elements to be verified and configured without user intervention. Further, embodiments of the present disclosure provide a user with an integrated hardware resource set having an integrated solution that automatically discovers and configures the resources and provides a single and/or unified management interface for the system as a cloud computing environment.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for automatically configuring a set of resources for deployment as a computing environment, the method comprising:
executing a configuration management application, the configuration management application configured to:
automatically connect to and discover each hardware element forming a networked set of resources;
determine whether each discovered hardware element is specified for the computing environment;
responsive to determining that each discovered hardware element is specified for the computing environment, determine a configuration setting for each respective discovered hardware element;
responsive to determining that the configuration setting of the discovered hardware element conflicts with a desired configuration setting for deployment of the discovered hardware element, automatically configure the discovered hardware element to the desired configuration setting; and
automatically load and configure a management interface to enable deployment of the networked set of resources as a computing environment.

2. The method of claim 1, wherein the configuration management application is configured to verify, for a designated port of a switch, that a particular hardware element is connected to the designated port.

3. The method of claim 1, wherein the configuration management application is configured to
automatically configure a switch, the switch comprising a plurality of ports;
verify, via a first designated port of the switch, a management module connected to the first designated port;
responsive to verifying the management module, determine whether the management module is configured for deployment;
responsive to determining that the management module is not configured for deployment, automatically configure the management module;
access and automatically configure, via the management module, at least one compute node controlled by the management module;
verify, via a second designated port of the configured switch, a storage controller connected to the second designated port;
responsive to verifying the storage controller, determine whether the storage controller is configured for deployment; and
responsive to determining that the storage controller is not configured for deployment, automatically configure the storage controller for managing at least one storage device.

4. The method of claim 1, further comprising accessing, by the configuration management application, configuration data indicating a physical location of each hardware element of the networked set of resources relative to each other.

5. The method of claim 1, further comprising illuminating an indicator while configuring a respective hardware element.

6. The method of claim 1, further comprising storing information associated with a configuration of a respective hardware element.

7. The method of claim 1, further comprising establishing an isolated network for configuring the networked set of resources.

8. A system for automatically configuring a set of resources for deployment as a computing environment, the system comprising:
a processor unit operable to execute a configuration management application, the configuration management configured to:
automatically connect to and discover each hardware element forming a networked set of resources;
determine whether each discovered hardware element is specified for the computing environment;
responsive to determining that each discovered hardware element is specified for the computing environment, determine a configuration setting for each respective discovered hardware element;
responsive to determining that the configuration setting of the discovered hardware element conflicts with a desired configuration setting for deployment of the discovered hardware element, automatically configure the discovered hardware element to the desired configuration setting; and
automatically load and configure a management interface to enable deployment of the networked set of resources as a computing environment.

9. The system of claim 8, wherein the configuration management application is configured to verify, for a designated port of a switch, that a particular hardware element is connected to the designated port.

10. The system of claim 8, wherein the configuration management configured to:
automatically configure a switch, the switch comprising a plurality of ports;
verify, via a first designated port of the switch, a management module connected to the first designated port;
responsive to verifying the management module, determine whether the management module is configured for deployment;
responsive to determining that the management module is not configured for deployment, automatically configure the management module;
access and automatically configure, via the management module, at least one compute node controlled by the management module;
verify, via a second designated port of the configured switch, a storage controller connected to the second designated port;
responsive to verifying the storage controller, determine whether the storage controller is configured for deployment; and
responsive to determining that the storage controller is not configured for deployment, automatically configure the storage controller for managing at least one storage device.

11. The system of claim 8, wherein the configuration management application is operable to access configuration data indicating a physical location of each hardware element of the networked set of resources relative to each other.

12. The system of claim 8, wherein the configuration management application is operable to illuminate an indicator while configuring a respective hardware element.

13. The system of claim 8, wherein the configuration management application is operable to store information associated with a configuration of each respective hardware element.

14. A computer program product for automatically configuring a set of resources for deployment as a computing environment, the computer program product comprising:
a computer readable storage medium having computer readable program code embodied therewith, the computer readable program code comprising computer readable program code configured to:
automatically connect to and discover each hardware element forming a networked set of resources;
determine whether each discovered hardware element is specified for the computing environment;
responsive to determining that each discovered hardware element is specified for the computing environment, determine a configuration setting for each respective discovered hardware element;
responsive to determining that the configuration setting of the discovered hardware element conflicts with a desired configuration setting for deployment of the discovered hardware element, automatically configure the discovered hardware element to the desired configuration setting; and
automatically load and configure a management interface to enable deployment of the networked set of resources as a computing environment.

15. The computer program product of claim 14, wherein the computer readable program code is configured to verify, for a designated port of a switch, that a particular hardware element is connected to the designated port.

16. The computer program product of claim 14, wherein the computer readable program code is configured to:
automatically configure a switch, the switch comprising a plurality of ports;
verify, via a first designated port of the switch, a management module connected to the first designated port;
responsive to verifying the management module, determine whether the management module is configured for deployment;
responsive to determining that the management module is not configured for deployment, automatically configure the management module;
access and automatically configure, via the management module, at least one compute node controlled by the management module;
verify, via a second designated port of the configured switch, a storage controller connected to the second designated port;
responsive to verifying the storage controller, determine whether the storage controller is configured for deployment; and
responsive to determining that the storage controller is not configured for deployment, automatically configure the storage controller for managing at least one storage device.

17. The computer program product of claim 16, wherein the computer readable program code is configured to access configuration data indicating a physical location of each hardware element of the networked set of resources relative to each other.

18. The computer program product of claim 16, wherein the computer readable program code is configured to store information associated with a configuration of each respective hardware element.

19. The computer program product of claim 16, wherein the computer readable program code is configured to establish an isolated network for configuring the networked set of resources.

20. The computer program product of claim 16, wherein the computer readable program code is configured to illuminate an indicator while configuring a respective hardware element.
